(19) United States
(12) Patent Application Publication
(10) Pub. No.: US 2019/0092164 A1
(43) Pub. Date: Mar. 28, 2019

(54) VEHICLE PROPELLER SHAFT

(71) Applicant: TOYOTA JIDOSHA KABUSHIKI KAISHA, Toyota-shi (JP)

(72) Inventors: Tatsuya ISONO, Toyota-shi (JP); Atsuo MIKAZUKI, Toyota-shi (JP)

(73) Assignee: TOYOTA JIDOSHA KABUSHIKI KAISHA, Toyota-shi (JP)

(21) Appl. No.: 16/139,595

(22) Filed: Sep. 24, 2018

(30) Foreign Application Priority Data
Sep. 22, 2017 (JP) 2017-183054

(51) Int. Cl. B60K 17/22

(52) U.S. Cl. CPC B60K 17/22; F16C 3/023

(57) ABSTRACT

A vehicle propeller shaft for transmitting a rotating force output from a drive power source to a driving wheel, comprises: a large diameter tube portion having at one end a diameter reduction portion with a diameter reduced toward an end portion; a small diameter tube portion having at one end a diameter expansion portion with a diameter expanded toward an end portion; and a welded portion joining the end portion of the diameter reduction portion and the end portion of the diameter expansion portion by welding.

This application claims priority from Japanese Patent Application No. 2017-183054 filed on Sep. 22, 2017, the disclosure of which is herein incorporated by reference in its entirety.

### BACKGROUND OF THE INVENTION

### Field of the Invention

The present invention relates to a vehicle propeller shaft and more particularly to a technique of reducing collision energy at the time of collision in a vehicle propeller shaft that is disposed in a longitudinal direction of a vehicle and transmits power from a drive power source of the vehicle to the rear wheel side.

### Description of the Related Art

By forming a stepped portion having a different outer diameter on a portion of a vehicle propeller shaft and designing such that the stepped portion is buckled, i.e., deformed in a collision direction by an impact at the time of collision of a vehicle, collision energy is absorbed at the time of collision of the vehicle in a known technique. For example, this corresponds to the vehicle propeller shaft disclosed in Patent Document 1. The vehicle propeller shaft of Patent Document 1 has a structure in which a stepped portion of a propeller shaft is buckled and deformed in a traveling direction of a vehicle, i.e., an axial direction of the propeller shaft, when collision energy is received from the front side of the vehicle at the time of collision of the vehicle, and an impact force generated at the time of collision is mitigated by the structure absorbing the energy generated by this collision.

### CITATION LIST

Patent Document 1: Japanese Laid-Open Patent Publication No. 2002-79840

### SUMMARY OF THE INVENTION

### Technical Problem

In the vehicle propeller shaft, it is desirable to reduce the energy by which a deformation of the propeller shaft is started in the collision direction at the time of vehicle collision so that the vehicle propeller shaft starts deforming even in a minor collision, i.e., that an axial compressive strength can be set lower. Although the axial compressive strength can be set lower by reducing a thickness of a material forming the vehicle propeller shaft, this also reduces a torque capacity that is torque amount transmittable through the vehicle propeller shaft, i.e., a permissible drive torque for driving a vehicle. Therefore, it is difficult to reduce the axial compressive strength of the vehicle propeller shaft while maintaining the torque capacity of the vehicle propeller shaft.

The present invention was conceived in view of the situations and it is therefore an object of the present invention to provide a vehicle propeller shaft having the axial compressive strength of the vehicle propeller shaft set lower at the time of vehicle collision and maintaining a rotational-direction torque capacity of the vehicle propeller shaft.

### Solution to Problem

To achieve the object, a first aspect of the present invention provides a vehicle propeller shaft (a) for transmitting a rotating force output from a drive power source to a driving wheel, comprising: (b) a large diameter tube portion having at one end a diameter reduction portion with a diameter reduced toward an end portion; a small diameter tube portion having at one end a diameter expansion portion with a diameter expanded toward an end portion; and a welded portion joining the end portion of the diameter reduction portion and the end portion of the diameter expansion portion by welding.

A second aspect of the present invention provides the vehicle propeller shaft recited in the first aspect of the invention, wherein the small diameter tube portion is thicker than the large diameter tube portion

A third aspect of the present invention provides the vehicle propeller shaft recited in the first or second aspect of the invention, wherein the large diameter tube portion includes a straight tube portion having a constant diameter at an end portion on the side opposite to the diameter reduction portion, and wherein the straight tube portion is joined by welding to an end portion of other tubular member constituting the vehicle propeller shaft.

A fourth aspect of the present invention provides the vehicle propeller shaft recited in the first or second aspect of the invention, wherein the small diameter tube portion has female splines formed on a portion of an inner circumferential surface for spline fitting relatively movable in an axial direction and relatively non-rotatable around an axis.

A fifth aspect of the present invention provides the vehicle propeller shaft recited in the first or second aspect of the invention, wherein end surfaces of the diameter reduction portion and the diameter expansion portion in a direction of a rotation axis of the vehicle propeller shaft are inclined by a predetermined angle relative to a vertical plane of the rotation axis of the propeller shaft, respectively.

### Advantageous Effects of the Invention

According to the first aspect of the invention, the propeller shaft for transmitting a rotating force output from the drive power sources to the driving wheels includes the large diameter tube portion having at one end the diameter reduction portion with a diameter reduced toward an end portion thereof, the small diameter tube portion having at one end the diameter expansion portion with a diameter expanded toward an end portion thereof, and the welded portion for joining the end portion of the diameter reduction portion and the end portion of the diameter expansion portion by welding. As a result, while only the compressive load is applied to the welded portion at the time of collision if the welded portion is disposed on a straight (i.e., equal diameter) cylindrical portion of the large diameter tube portion or the small diameter tube portion, the bending load is applied together with the compression load to the welded portion since the welded portion is disposed at the end portions of the diameter reduction portion of the large diameter tube portion and the diameter expansion portion of the small diameter tube portion. The vicinity of the welded portion is a portion having a weak proof strength as compared to the other portions and is easily buckled and fractured due to the application of the bending load, so that the axial compressive strength can be reduced such that the vehicle propeller shaft starts deforming in the axial direction at the time of vehicle collision. The torque capacity in the rotational direction transmittable by the vehicle propeller shaft can be maintained.

According to the vehicle propeller shaft of the second aspect of the invention, the small diameter tube portion is thicker than the large diameter tube portion. As a result, the rigidity of the diameter expansion portion of the small diameter tube portion becomes larger than the rigidity of the diameter reduction portion of the large diameter tube portion, and when the axial deformation of the vehicle propeller shaft occurs, the small diameter tube portion is more easily entered the inside of the large diameter tube portion due to buckling. This can suppress an influence on the other vehicle components due to deformation out of the axial direction.

According to the vehicle propeller shaft of the third aspect of the invention, the large diameter tube portion includes the straight tube portion having a constant diameter at the end portion on the side opposite to the diameter reduction portion, and the straight tube portion is joined by welding to an end portion of other tubular member constituting the propeller shaft rear portion. As a result, the welding between the straight tube portion and the other tubular member to be welded can be the same as the conventional structure, so that the other tubular member conventionally used can be used without change.

According to the vehicle propeller shaft of the fourth aspect of the invention, the small diameter tube portion has female splines formed on a portion of the inner circumferential surface for spline fitting relatively movable in the axial direction and relatively non-rotatable around the axis. As a result, even when the vehicle propeller shaft has fractured in the vicinity of the welded portion at the time of collision of the vehicle, the member provided with the male splines incorporated inside the small diameter tube portion can move in the axial direction so that the impact is more easily absorbed at the time of the collision.

According to the vehicle propeller shaft of the fifth aspect of the invention, the end surfaces between the diameter reduction portion and the diameter expansion portion in the direction of the rotation center axis of the vehicle propeller shaft are inclined by the predetermined angle relative to the vertical plane of the rotation center axis of the vehicle propeller shaft. As a result, the diameter reduction portion and the diameter expansion portion are restrained from mutually moving in the radial direction and are easily axially aligned at the time of welding.

### BRIEF DESCRIPTION OF THE DRAWINGS

FIG. 1 is a diagram for explaining a schematic configuration of a vehicle to which the present invention is applied and for explaining a schematic position of a propeller shaft in the vehicle;

FIG. 2 is a view for explaining an example of the propeller shaft provided in the vehicle of FIG. 1.

FIG. 3 is a cross-sectional view and a front view of an example of a welded portion between a diameter reduction portion and a diameter expansion portion used for the propeller shaft of FIG. 2.

FIG. 4 is a cross-sectional view of an example in which a predetermined angle is provided with respect to the rotation axis of the propeller shaft in a cross section for each of the diameter reduction portion and the diameter expansion portion, used for the propeller shaft of FIG. 2.

### DESCRIPTION OF THE PREFERRED EMBODIMENTS

An example of the present invention will now be described in detail with reference to the drawings. In the following examples, the figures are simplified or deformed as needed, and portions are not necessarily precisely drawn in terms of dimension ratio, shape, etc.

### Example 1

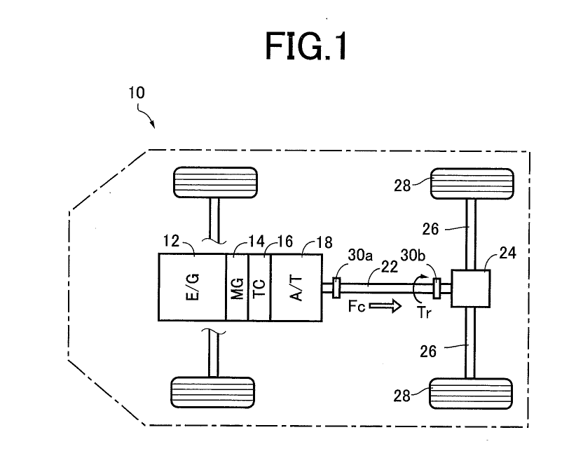

FIG. 1 is a schematic for explaining a drive train of a hybrid vehicle 10 to which the present invention is applied. In FIG. 1, the vehicle 10 is of the FR (front-engine rear-drive) type and includes an engine 12 that is an internal combustion engine such as a gasoline engine or a diesel engine serving as a drive power source for running, and a motor generator 14 functioning as an electric motor and a generator as a drive power source. Outputs, i.e., rotating forces, of the engine 12 and the motor generator 14 are transmitted from a torque converter 16 that is a fluid type power transmission device to an automatic transmission 18 and are further transmitted via a propeller shaft 22 to a differential gear device 24 to rotate axles 26 so that left and right driving wheels 28 are driven.

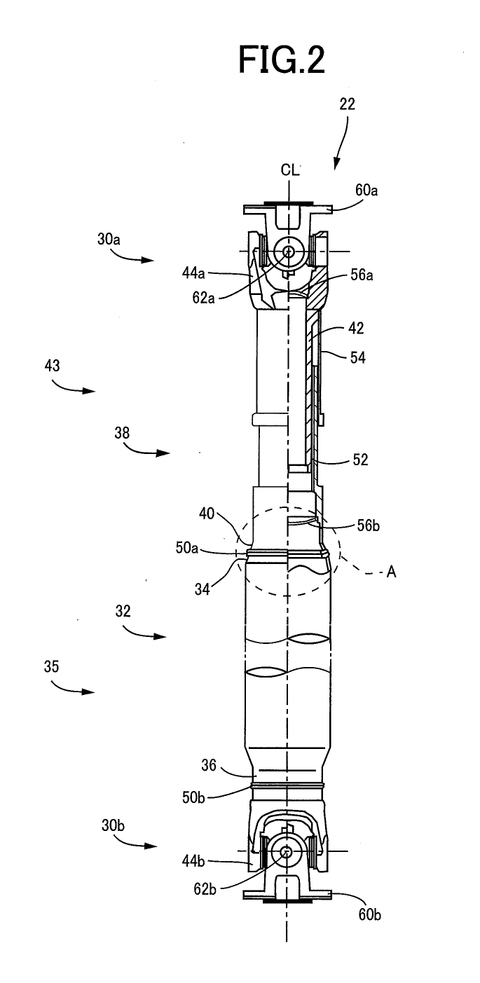

FIG. 2 is a view for explaining the vehicle propeller shaft 22 to which the present invention is applied, and FIG. 2 includes a cross-sectional view of the vehicle propeller shaft 22 in an upper right portion and a front view showing an outer shape in the other portion. The propeller shaft 22 is made up of a propeller shaft front portion 43 and a propeller shaft rear portion 35, and the propeller shaft front portion 43 is connected to an output shaft not shown of the automatic transmission part 18 by a first universal joint 30a, while the propeller shaft rear portion 35 is connected to an input shaft not shown of the differential gear device 24 by a second universal joint 30b.

The first universal joint 30a is made up of a first yoke 44a joined by welding to a spline shaft portion 42 to constitute a part of the propeller shaft front portion 43, a yoke 60a joined to the output shaft of the automatic transmission 18, and a joint cross 62a freely rotatably connecting these yokes. The second universal joint 30b is made up of a second yoke 44b constituting a part of the propeller shaft rear portion 35, a yoke 60b joined to the input shaft of the differential gear device 24, and a joint cross 62b freely rotatably connecting these yokes. Due to the first universal joint 30a and the second universal joint 30b, rotation input from the automatic transmission 18 is transmitted to the differential gear device 24 via the propeller shaft 22 even when the driving wheels 28 move up and down due to a road surface condition, i.e., even when the propeller shaft 22 is inclined. Even when the driving wheels 28 move up or down and an angular variation occurs between the output shaft of the automatic transmission 18 connected to the first universal joint 30a and the propeller shaft 22 so that a change occurs in the rotational speed of the first universal joint 30a, an opposite angular variation occurs between the input shaft of the differential gear device 24 connected to the second universal joint 30b and the propeller shaft 22, and the change in the rotational speed of the first universal joint 30a can be cancelled.

The propeller shaft front portion 43 is made up of a small diameter tube portion 38 having spline teeth not shown on an inner circumferential surface in a spline fitting portion 52 that is a portion of the inner circumferential surface, a spline shaft portion 42 having spline teeth not shown on a portion of an outer circumferential surface, the first yoke 44a, and a cover member 54 for preventing foreign matter from entering the spline fitting portion 52. A gap is set between the inner circumference of the cover member 54 and the outer circumference of the small diameter tube portion 38 is set narrow such that foreign matter is prevented from entering into the spline fitting portion 52. The small diameter tube portion 38 and the spline shaft portion 42 are coupled to each other at the spline fitting portion 52 relatively movably in an axial direction of a rotation center axis CL of the propeller shaft 22 and relatively non-rotatably around the rotation center axis CL. Specifically, female splines for spline fitting are formed on a portion of the inner circumferential surface of the small diameter tube portion 38, and male splines for spline fitting are formed on a portion of the outer circumferential surface of the spline shaft portion 42, thereby the relative movement is enabled in the axial direction of the rotation center axis CL. The small diameter tube portion 38 including a diameter expansion portion 40 is configured to have an inner diameter to increase toward a large diameter tube portion 32 to form a structure such that after a compression force is applied to the propeller shaft 22 due to a collision of the vehicle 10 and the shaft starts buckling near a first welded portion 50a and fractures, the spline shaft portion 42 enters the inside of the small diameter tube portion 38 and moves in the axial direction of the rotation center axis CL, so that the impact at the time of collision is easily absorbed. A lid 56a fitted into the inner circumference of the small diameter tube portion 38 prevents grease sealed within the cylindrical spline shaft portion 42 from flowing out toward the first universal joint, and similarly, a lid 56b fitted into the inner circumference of the small diameter tube portion 38 prevents grease sealed within the small diameter tube portion 38 from flowing out toward the large diameter tube portion 32.

The spline shaft portion 42 is integrally fixed by welding to the first yoke 44a constituting a portion of the first universal joint 30a. The small diameter tube portion 38 and the large diameter tube portion 32 are integrally fixed to each other at the first welded portion 50a. The second yoke 44b forming the propeller shaft rear portion 35 and a straight tube portion 36 having a smaller diameter than the large diameter tube portion 32 are integrally fixed to each other at a second welded portion 50b formed by welding. For welding of these portions, for example, a welding method such as friction pressure welding, MIG (metal inert gas) welding, and arc welding is selected based on requirements for material and processing accuracy of members.

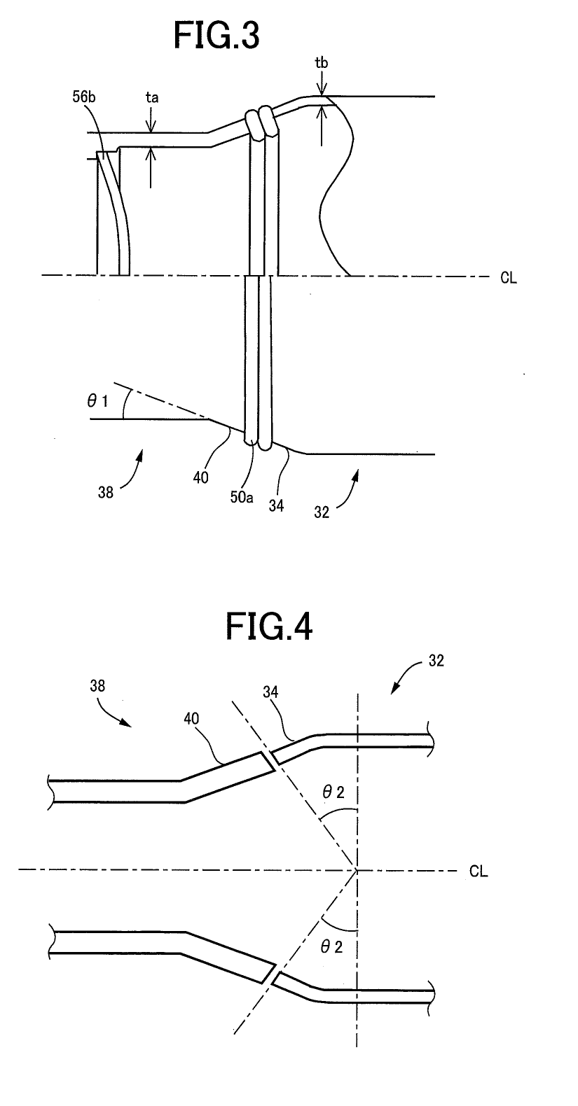

FIG. 3 is an enlarged view of a portion A of FIG. 2, showing a cross-sectional view in an upper half and a front view in a lower half. The portion A shows a part of a straight (i.e., equal diameter) cylindrical portion of the small diameter tube portion 38 and the diameter expansion portion 40 having a diameter expanded from the straight tube portion of the small diameter tube portion 38 toward an end portion thereof as well as a straight cylindrical portion of the large diameter tube portion 32 and a diameter reduction portion 34 having a diameter reduced from the straight tube portion of the large diameter tube portion 32 toward an end portion thereof. The diameter expansion portion 40 has a slope of a predetermined angle θ1 relative to the rotation center axis CL of the propeller shaft 22. The first welded portion 50a having a protrusion on the outer circumferential side joined by welding is provided at a boundary between the diameter expansion portion 40 and the diameter reduction portion 34. Generally, in the case of joining by welding, strength is reduced in the vicinity of the first welded portion 50a, i.e., a welded position, due to a change in quality caused by heat during welding of material, and the vicinity of the welded position tends to have lower strength as compared to the other positions. The diameter expansion portion 40 of the small diameter tube portion 38 and the straight cylindrical portion near the diameter expansion portion 40 have the same thickness ta. As shown in FIG. 2, the thickness of the small diameter tube portion 38 fitted by spline fitting to the spline shaft portion 42 is made larger than the thickness ta of the diameter expansion portion 40 so as to maintain sufficient strength in the spline fitting. The diameter reduction portion 34 and the other portion of the large diameter tube portion 32 each have a thickness tb, and the diameter reduction portion 34 has a slope of a predetermined angle θ1 relative to the rotation center axis CL of the propeller shaft 22. This angle θ1 is substantially the same as the angle between the diameter expansion portion 40 and the rotation center axis CL. Since the large diameter tube portion 32 occupies a large portion of the propeller shaft 22 in the length in the axial direction of the rotation center axis CL of the propeller shaft 22, the thin thickness tb is selected for decreasing the weight of the propeller shaft 22 to reduce the fuel consumption of the vehicle 10, for example. The thickness tb can also partially be increased as needed.

If a compressive load Fc shown in FIG. 1 is applied at the time of collision of the vehicle 10, the buckling deformation is started at a portion having the smallest axial compressive strength in the direction of the rotation center axis CL of the propeller shaft 22, and the shock at the time of the collision is absorbed. As described above, the strength tends to decrease in the vicinity of the welded position as compared to the other positions, so that the buckling deformation is started in the vicinity of the welded position if the thickness is uniform in the propeller shaft 22. Additionally, as shown in FIG. 3, if the welding is performed in a portion having the predetermined angle θ1 relative to the rotation center axis CL of the propeller shaft 22, i.e., in the first welded portion 50a that is a joint portion between the diameter expansion portion 40 and the diameter reduction portion 34, a bending load is generated in the circumferential direction in addition to the compressive force in the axial direction of the rotational center axis CL, and buckling is started by a smaller compressive load Fc to the propeller shaft 22 as compared to a case when the welded portion is formed in the straight cylindrical portion, in which only the compressive force in the axial direction of the rotational center axis CL is applied to the welded portion. A permissible rotation torque Tr in the rotation direction, i.e., a torque capacity, of the propeller shaft 22 is affected by the distance from the rotation center axis CL, the thickness of the propeller shaft 22, the strength reduction due to welding, etc. and is not affected by the angle θ1 formed by the diameter expansion portion 40 and the diameter reduction portion 34 relative to the rotation center axis CL. Therefore, the torque capacity of the propeller shaft 22 is not reduced by disposing the first welded portion 50a at the portion having the predetermined angle θ1 relative to the rotation center axis CL of the propeller shaft 22.

In FIG. 3, the thickness to of the diameter expansion portion 40 and the portion of the small diameter tube portion 38 adjacent to the diameter expansion portion 40 is set larger than the thickness tb of the large diameter tube portion 32. As a result, rigidity of the diameter expansion portion 40 of the small diameter tube portion 38 in the vicinity of the first welded portion 50a is larger than rigidity of the diameter reduction portion 34 of the large diameter tube portion 32, and if the compressive load Fc is applied to the propeller shaft 22 and the buckling occurs in the vicinity of the first welded portion 50a, the buckling occurs in the diameter reduction portion 34 of the large diameter tube portion 32 before a change in shape occurs in the small diameter tube portion 38 due to the high rigidity of the diameter expansion portion 40, so that the small diameter tube portion 38 moves toward the large diameter tube portion 32 and enters the inside of the large diameter tube portion 32.

As shown in the cross-sectional view of the small diameter tube portion 38 and the spline shaft portion 42 in FIG. 2, the inner diameter of the small diameter tube portion 38 is set larger than the outer diameter of the spline shaft portion 42 on which the male splines are formed. The female splines are formed inside the small diameter tube portion 38, and the spline shaft portion 42 can move to the inside of the large diameter tube portion 32 as the compressive deformation of the propeller shaft 22 increases. The movement of the small diameter tube portion 38 of the propeller shaft 22 entering the inside of the large diameter tube portion 32 is called a “slide”.

According to the vehicle propeller shaft 22 of this example, the propeller shaft 22 for transmitting a rotating force output from the engine 12 and the motor generator 14 serving as drive power sources to the driving wheels 28 includes the large diameter tube portion 32 having at one end the diameter reduction portion 34 with a diameter reduced toward an end portion thereof, the small diameter tube portion 38 having at one end the diameter expansion portion 40 with a diameter expanded toward an end portion thereof, and the first welded portion 50a for joining the end portion of the diameter reduction portion 34 and the end portion of the diameter expansion portion 40 by welding. As a result, while only the compressive load is applied to the first welded portion 50a at the time of collision if the first welded portion 50a is disposed on the straight cylindrical portion of the large diameter tube portion 32 or the small diameter tube portion 38, the bending load is applied together with the compression load to the first welded portion 50a since the first welded portion 50a is disposed at the end portions of the diameter reduction portion 34 of the large diameter tube portion 32 and the diameter expansion portion 40 of the small diameter tube portion 38. The vicinity of the welded portion is a portion having a weak proof strength as compared to the other portions and is easily buckled and fractured due to the application of the bending load, so that the axial compressive strength can be reduced such that the propeller shaft 22 starts deforming in the axial direction at the time of vehicle collision. The torque capacity in the rotational direction transmittable by the propeller shaft 22 can be maintained without reduction.

According to the vehicle propeller shaft 22 of this example, the small diameter tube portion 38 is thicker than the large diameter tube portion 32. As a result, the rigidity of the diameter expansion portion 40 of the small diameter tube portion 38 becomes larger than the rigidity of the diameter reduction portion 34 of the large diameter tube portion 32, and when the axial deformation of the propeller shaft 22 occurs, the small diameter tube portion 38 is more easily buckled to enter the inside of the large diameter tube portion 32. This can suppress an influence on the other vehicle components due to deformation out of the axial direction.

According to the vehicle propeller shaft 22 of this example, the large diameter tube portion 32 includes the straight tube portion 36 having a constant diameter at the end portion on the side opposite to the diameter reduction portion 34, and the straight tube portion 36 is joined by welding to an end portion of other tubular member constituting the propeller shaft rear portion 35. As a result, the welding between the straight tube portion 36 and the other tubular member to be welded can be the same as the conventional structure, so that the other tubular member conventionally used can be used without change. Although the straight tube portion 36 is smaller in diameter than the large diameter tube portion 32 in the example described above, the present invention is not particularly limited thereto, and the same effect can be expected even if the straight tube portion 36 is larger in diameter than the large diameter tube portion 32.

According to the vehicle propeller shaft 22 of this example, the small diameter tube portion 38 has female splines formed on a portion of the inner circumferential surface for spline fitting relatively movable in the direction of the rotation center axis CL of the propeller shaft 22 and relatively non-rotatable around the axis. As a result, even when the vicinity of the first welded portion 50a of the propeller shaft 22 has fractured at the time of collision of the vehicle 10, the member provided with the male splines incorporated inside the small diameter tube portion 38 can move in the axial direction so that the impact is more easily absorbed at the time of the collision.

Another example of the present invention will be described. In the following description, the potions common to the examples are denoted by the same reference numerals and will not be described.

### Example 2

FIG. 4 is a cross-sectional view of another example showing the diameter expansion portion 40 and a part of the straight cylindrical portion of the small diameter tube portion 38 as well as the diameter reduction portion 34 reduced toward the end portion of the large diameter tube portion 32 and a part of the straight cylindrical portion of the large diameter tube portion 32 before welding. The cross section of the diameter expansion portion 40 on a side to be welded is not perpendicular to the direction of the rotation center axis CL of the propeller shaft 22 and has a plane inclined by a predetermined angle θ2 from a vertical plane. Similarly, the cross section of the diameter reduction portion 34 on a side to be welded is not perpendicular to the direction of the rotation center axis CL of the propeller shaft 22 and has a plane inclined by the predetermined angle θ2 from the vertical plane.

According to this example, the end surfaces between the diameter reduction portion 34 and the diameter expansion portion 40 in the direction of the rotation center axis CL of the propeller shaft 22 are inclined by the predetermined angle θ2 relative to the vertical plane of the rotation center axis CL of the propeller shaft 22. As a result, the diameter reduction portion 34 and the diameter expansion portion 40 are restrained from mutually moving in the radial direction and are easily axially aligned at the time of welding.

Although the examples of the present invention have been described with reference to the drawings, the present invention is also applied in other forms.

In Examples 1 and 2 described above, the hybrid vehicle has the engine 12 and the motor generator 14 as the drive power sources; however, the present invention is not particularly limited to the hybrid vehicle and is applicable to FR (front-engine rear-drive type) vehicles having any of the gasoline engine, the diesel engine, the motor generator 14, etc. as a single drive power source such that the rotating force of the drive power source is transmitted through the propeller shaft 22 to the driving wheel 28.

In the examples described above, the torque converter 16 and the automatic transmission 18 are used; however, the torque reducer 16 may not be used. The automatic transmission 18 may be implemented by using any of multi-speed automatic transmission, belt-type continuously variable transmissions having a transmission belt wound around a pair of variable pulleys, etc.

In the examples described above, the second welded portion 50b is a joining portion between the second yoke 44b and the straight tube portion 36 of the large diameter tube portion 32; however, the second welded portion may be formed in another equal diameter cylindrical portion, for example, the equal diameter cylindrical portion of the large diameter tube portion 32. Because, the welded portion formed in the equal diameter cylindrical portion having the same thickness tb has a higher axial compressive strength than the first welded portion 50a having the predetermined angle θ1 relative to the rotational center axis CL of the propeller shaft 22. The propeller shaft 22 may not have a cylindrical shape with a uniform outer diameter and may be changed in shape as needed into a hexagonal shape etc.

The above description is merely an embodiment, and the present invention can be implemented in variously modified and improved forms based on the knowledge of those skilled in the art.

### REFERENCE SIGNS LIST

12: Engine (Drive power source)
14: Motor generator (Drive power source)
22: Vehicle propeller shaft
28: Driving wheels
32: Large diameter tube portion
34: Diameter reduction portion
36: Straight tube portion
38: Small diameter tube portion
40: Diameter expansion portion
50a: First welded portion (Welded portion)
θ2: Predetermined angle

What is claimed is:

1. A vehicle propeller shaft for transmitting a rotating force output from a drive power source to a driving wheel, comprising:
a large diameter tube portion having at one end a diameter reduction portion with a diameter reduced toward an end portion;
a small diameter tube portion having at one end a diameter expansion portion with a diameter expanded toward an end portion; and
a welded portion joining the end portion of the diameter reduction portion and the end portion of the diameter expansion portion by welding.

2. The vehicle propeller shaft according to claim 1, wherein
the small diameter tube portion is thicker than the large diameter tube portion.

3. The vehicle propeller shaft according to claim 1, wherein
the large diameter tube portion includes a straight tube portion having a constant diameter at an end portion on the side opposite to the diameter reduction portion, and wherein the straight tube portion is joined by welding to an end portion of other tubular member constituting the vehicle propeller shaft.

4. The vehicle propeller shaft according to claim 2, wherein
the large diameter tube portion includes a straight tube portion having a constant diameter at an end portion on the side opposite to the diameter reduction portion, and wherein the straight tube portion is joined by welding to an end portion of other tubular member constituting the vehicle propeller shaft.

5. The vehicle propeller shaft according to claim 1, wherein
the small diameter tube portion has female splines formed on a portion of an inner circumferential surface for spline fitting relatively movable in an axial direction and relatively non-rotatable around an axis.

6. The vehicle propeller shaft according to claim 2, wherein
the small diameter tube portion has female splines formed on a portion of an inner circumferential surface for spline fitting relatively movable in an axial direction and relatively non-rotatable around an axis.

7. The vehicle propeller shaft according to claim 1, wherein
end surfaces of the diameter reduction portion and the diameter expansion portion in a direction of a rotation axis of the vehicle propeller shaft are inclined by a predetermined angle relative to a vertical plane of the rotation axis of the propeller shaft, respectively.

8. The vehicle propeller shaft according to claim 2, wherein
end surfaces of the diameter reduction portion and the diameter expansion portion in a direction of a rotation axis of the vehicle propeller shaft are inclined by a predetermined angle relative to a vertical plane of the rotation axis of the propeller shaft, respectively.
